(19) United States
(12) Patent Application Publication
(10) Pub. No.: US 2026/0361018 A1
(43) Pub. Date: Nov. 12, 2026

(54) EXOSKELETON FOR A SEPARABLE ELECTRICAL CONNECTOR

(71) Applicant: Eaton Intelligent Power Limited, Dublin (IE)

(72) Inventors: William Robert Luoma, Franklin, WI (US); Alex Teuteberg, Menomonee Falls, WI (US); Aleksandar Miljevic, Muskego, WI (US); Vaibhav S. Mule, Pune (IN); Robert Raymond Schuetz, Waukesha, WI (US); Alexander Groth, Brookfield, WI (US); Nicholas John Wainio, Wales, WI (US)

(21) Appl. No.: 19/662,619

(22) Filed: Apr. 29, 2026

(30) Foreign Application Priority Data
May 6, 2025 (IN) 202511043756

(51) Int. Cl. H01R 13/502; H01R 13/52; H01R 13/60; H01R 13/633

(52) U.S. Cl. CPC H01R 13/502; H01R 13/5202; H01R 13/60; H01R 13/6335

(57) ABSTRACT

A system includes: a separable electrical connector including: an elastomeric body; and an electrical conductor, at least part of the electrical conductor surrounded by the elastomeric body; and an exoskeleton configured to provide mechanical support to the separable electrical connector. The exoskeleton includes two or more attached pieces of material that define an exterior surface and an interior region. The elastomeric body is in the interior region.

### CROSS-REFERENCE TO RELATED APPLICATION

This application claims priority to Indian Patent Application No. 202511043756, filed May 6, 2025 and titled EXOSKELETON FOR A SEPARABLE ELECTRICAL CONNECTOR, which is incorporated herein by reference in its entirety.

### TECHNICAL FIELD

This disclosure relates to an exoskeleton for a separable electrical connector and an assembled system that includes an exoskeleton and a separable electrical connector.

### BACKGROUND

A separable electrical connector can be repeatedly attached to and disconnected from a bushing. When the separable electrical connector is attached to the bushing, the electrical connector provides an electrically conductive path between a device associated with a bushing and a load. For example, the separable electrical connector may be used to connect electrical transmission and distribution equipment and electrical sources within an electrical system.

### SUMMARY

In one aspect, a system includes: a separable electrical connector including: an elastomeric body; and an electrical conductor, at least part of the electrical conductor surrounded by the elastomeric body; and an exoskeleton configured to provide mechanical support to the separable electrical connector. The exoskeleton includes two or more attached pieces of material that define an exterior surface and an interior region. The elastomeric body is in the interior region.

Implementations may include one or more of the following features.

The exoskeleton also may include a pulling feature that extends from the exterior surface. The system of also may include a support leg configured to be extended between the exterior surface and an external object.

The exoskeleton also may include a handle that extends from the exterior surface. The handle may be configured to be grasped by a human operator.

Each of the two or more attached pieces may include an inner side that faces the interior region, and the system also may include one or more wire routing features on the inner side of at least one of the two or more attached pieces. At least one of the one or more wire routing features may include an electrically conductive trace on the inner side of at least one of the attached pieces.

Each of the two or more attached pieces may be a piece of rigid material.

Each of the two or more attached pieces may be a piece of semi-rigid material.

Each of the two or more attached pieces may be formed as an individual piece of material prior to being attached.

The exterior surface may be electrically conductive.

The system also may include a semiconductive elastomeric shell on at least part of the exterior surface.

The elastomeric body may extend in at least two directions.

In another aspect, an exoskeleton for a separable electrical connector includes a plurality of individual solid pieces configured to be attached to each other as a single-piece structure. The single-piece structure including an interior region and an exterior surface, the interior region configured to enclose at least part of an insulating body of the separable electrical connector, each of the individual solid pieces is pre-formed as a piece of material prior to being attached to one or more of other of the individual solid pieces, and each of the individual solid pieces includes an inner side that faces the interior region. The exoskeleton also includes a pulling feature that extends from the exterior surface; a handle that extends from the exterior surface and is configured to be grasped by a human operator; and a support leg that extends from the exterior surface and is configured to support the exoskeleton relative to an external object.

Implementations may include one or more of the following features.

At least one inner side includes a channel configured to route an electrical wire.

Each individual solid piece may be a piece of rigid material.

In some implementations, when the individual solid pieces are attached to each other as the single-piece structure, the single-piece structure is fluidly sealed.

The pulling feature may be configured for interaction with a hotstick.

In some implementations, when the individual solid pieces are attached to each other as the single-piece structure, the single-piece structure provides mechanical support to the elastomeric electrical connector and counteracts a cantilever force experienced by the elastomeric electrical connector.

Implementations of any of the techniques described herein may include an apparatus, a system, an exoskeleton for an electrical connector, an assembled system that includes an exoskeleton and a separable electrical connector, a method, or a system. The details of one or more implementations are set forth in the accompanying drawings and the description below. Other features will be apparent from the description and drawings, and from the claims.

### DRAWING DESCRIPTION

FIG. 1A is a side cross-sectional view of an interior region of a cabinet.

FIG. 1B is an end view of the interior region of FIG. 1A.

FIG. 2A is a block diagram of an electrical power system that includes a separable electrical connector.

FIG. 2B is a side block diagram that shows additional details of the electrical connector of FIG. 2A.

FIG. 2C is an end view of the electrical connector of FIG. 2A.

FIG. 3A is an exterior perspective view of an assembled system.

FIG. 3B shows the system of FIG. 3A in a disassembled state.

FIG. 4A is an exterior side view of another assembled system.

FIG. 4B is a cross-sectional side view of the assembled system of FIG. 4A.

FIG. 5 is a rear-side exterior perspective view of two assembled systems mounted on respective bushings.

FIG. 6A is a front-side exterior perspective view of another assembled system.

FIG. 6B is a rear-side exterior view of the assembled system of FIG. 6A.

FIG. 6C is a partial exterior view of the assembled system of FIG. 6A.

FIG. 7A is a side-rear view of another assembled system.

FIG. 7B is a side perspective view of a bracing element.

FIGS. 8A and 8B show an interior of another cabinet.

FIGS. 9A and 9B show another assembled system.

FIG. 10A is an interior perspective view of another assembled system.

FIG. 10B is a side cross-sectional view of another assembled system.

### DETAILED DESCRIPTION

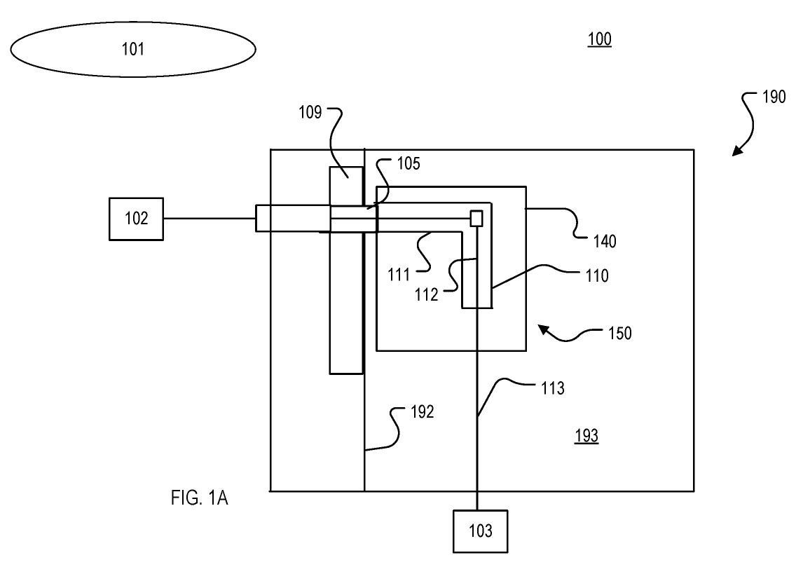

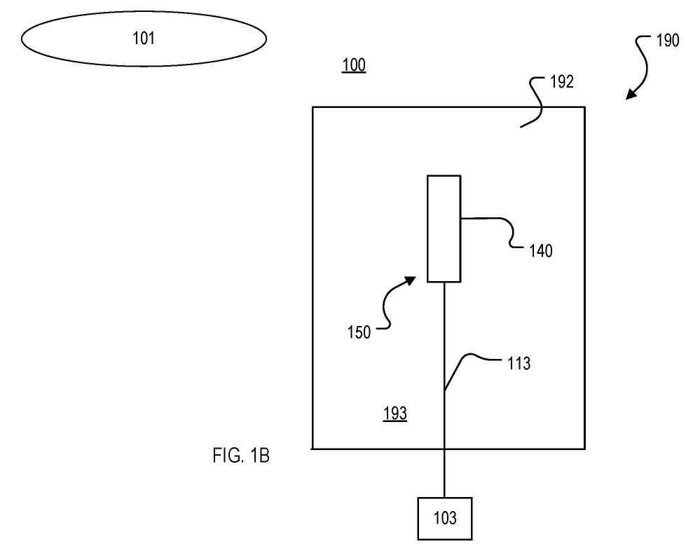

FIG. 1A is a side cross-sectional view of an interior region 193 of a cabinet 190, and FIG. 1B is an end view of the interior region 193. The cabinet 190 includes an electrical device 109 with a bushing 105 that passes through the interior wall 192. The electrical device 109 may be, for example, a sectionalizer, switchgear, capacitor bank, or a transformer. An assembled system 150 is mounted to the bushing 105. The assembled system 150 includes an exoskeleton 140 that encloses at least a portion of a separable electrical connector 110. As discussed below, the exoskeleton 140 provides mechanical support for the separable electrical connector 110 and reduces the effects of cantilever loading on the electrical connector 110, provides a platform for mounting accessories, provides additional sealing for the electrical connector 110, and/or accommodates low-voltage wiring.

The electrical connector 110 is a separable electrical connector that is configured to be connected to and disconnected from the bushing 105 repeatedly and without damaging the bushing 105 or the electrical connector 110. The electrical connector 110 includes an exterior 111 and a current path 112. When the electrical connector 110 is connected to the bushing 105 (as shown in FIG. 1A), electrical current can flow between a first node 102 and a second node 103 via the current path 112. When the electrical connector is disconnected or detached from the bushing 105, electrical current cannot flow between the first node 102 and the second node 103. The electrical connector 110 is any type of separable electrical connector and may be, for example, an elbow connector (such as shown in FIG. 1A), a T-shaped connector, a C-shaped connector, a U-shaped connector, or a separable connector that has a linear shape.

The electrical connector 110 may have a relatively high weight (for example, about 20 to 25 pounds or 9 to 11 kilograms). Moreover, when the electrical connector 110 is mounted on the bushing 105, the center of gravity is spatially displaced from the bushing 105. The weight and/or displacement of the center of gravity can result in the electrical connector 110 being susceptible to significant deflection and/or mechanical stress due to cantilever loading when mounted on the bushing 105.

On the other hand, the exoskeleton 140 provides mechanical support to the electrical connector 110 to address these challenges and improve the overall performance and usability of the electrical connector 110. The exoskeleton 140 is made of a rigid or semi-rigid material that counteracts the force and/or movement that the electrical connector 110 can experience while mounted to the bushing 105. A semi-rigid material is any material that is not completely rigid but is capable of resisting applied force(s) and deflection while also resisting cracking and flexural fatigue. Additionally, the exoskeleton 140 provides a convenient and accessible platform for attaching and/or anchoring accessory items that can aid in the installation and/or maintenance of the electrical connector 110. Moreover, the exoskeleton 140 may be used to route low-voltage wires and to compress small features on the exterior 111 of the electrical connector 110 to create one or more fluid-tight (for example, water-tight) seals along the exterior 111 of the electrical connector 110. Furthermore, the exoskeleton 140 may include exterior surface features (such as a pulling eye or an opening configured to receive a hook or other tool) that aid in the installation or removal of the assembled system 150.

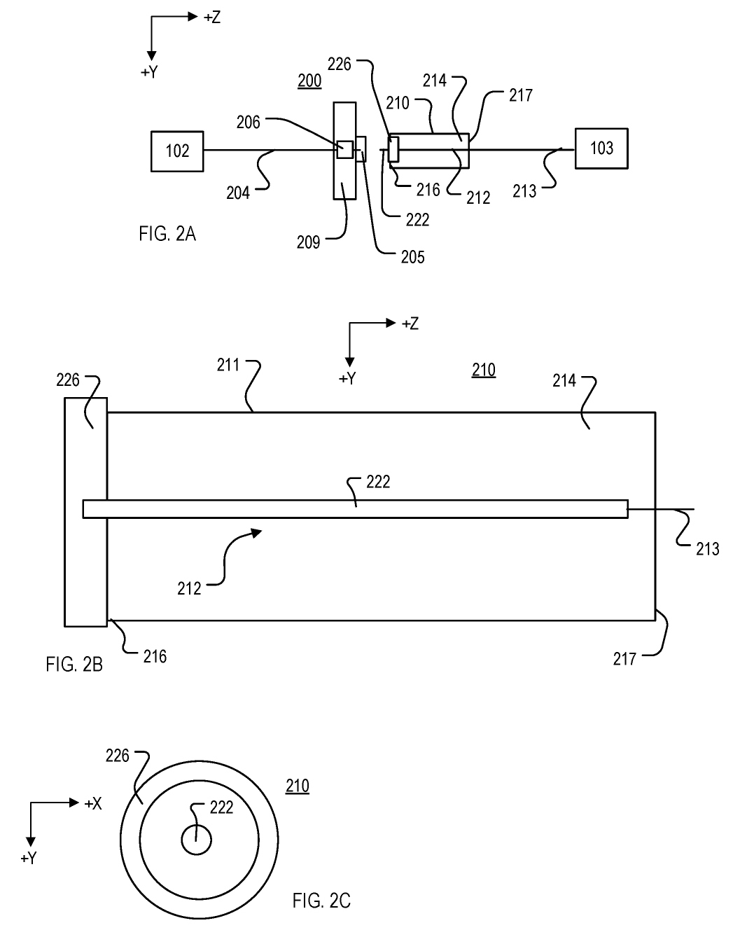

Before discussing various implementations of the exoskeleton 140, an overview of the system 100 and an example of an electrical connector 210 (FIGS. 2A-2C) are provided.

The electrical power system 100 includes an electrical grid 101 that distributes electricity through, for example, transmission lines, electrical cables, and/or other components capable of transmitting, receiving, and distributing electricity. The grid 101 also includes sources of AC electricity and other equipment that transfer and/or control electricity such as, for example, generators, substations, renewable energy sources, capacitor banks, transformers, and/or power stations. The electrical grid 101 distributes alternating current (AC) electrical energy but also may include direct current (DC) components. The electrical grid 101 may have an operating voltage of, for example, at least 1 kilovolt (kV), 12 kV, up to 34.5 kV, up to 38 kV, or 69 kV or higher, and may operate at a system frequency of, for example, 50 or 60 Hertz (Hz). All or portions of the grid 101 may be underground. The electrical grid 101 is shown as a single-phase, but may be a multi-phase (for example, three-phase) electrical grid.

The node 102 may be, for example, a connection point in the grid 101 or the output of a source of electricity, such as a generator. The node 103 may be a load 103 that receives energy from the node 102. Any type of device that utilizes, produces, and/or stores electricity may be the load 103. For example, the load 103 may be machinery, a lighting system, one or more motors, a transformer, or a combination of such devices. The load 103 may be a device that is capable of producing, consuming, and/or storing electricity. For example, the load 103 may be a battery. The load 103 may be in a residential, commercial, and/or industrial setting. In some implementations, the load 103 also provides energy back to the node 102.

The electrical connector 110 includes a cable 113 that electrically connects the current path 112 to the node 103. When the electrical connector 110 is attached to the bushing 105, the load 103 is electrically connected to the node 102 through the cable 113 and the current path 112.

FIG. 2A is a block diagram of an electrical power system 200 that includes a separable electrical connector 210. The electrical connector 210 is an example of an electrical connector that may be enclosed in the exoskeleton 140 (FIGS. 1A and 1B) but is shown without the exoskeleton 140 in FIGS. 2A-2C.

The electrical connector 210 is a relatively compact device that an operator can position and install manually on a bushing 205 of a device 209. When the electrical connector 210 is installed on the bushing 205, electrical current can flow between the node 102 and the node 103 via a current path 212 in the electrical connector 210. The electrical connector 210 may be capable of interrupting currents of 200 Amperes (A), 400 A, 600 A, between 200 A and 600 A, or greater than 600 A. The electrical connector 210 may be configured to have an AC operating voltage of, for example, 15 kilovolts (kV), 25 kV, 27 kV, 35 kV, 38 kV, or greater. In some implementations, the electrical connector 210 is rated to interrupt current on a 15 kV or 27 kV, 200A system and/or on a 38 kV, 400A system.

The electrical connector 210 includes a body 214 and a mechanical interface 226 that extends from an end 216 of the body 214. The body 214 is made of an electrically insulating material such as, for example, an elastomeric material, rubber, or a polymer. An elastomeric material is any material that has a low modulus and high elongation to define a flexible and/or resilient structure. An elastomeric material may be molded or formed into a molded structure with a resting or equilibrium shape and is able regain its original shape when a load is removed from the material. An elastomeric material may include one or more elastic substances resembling rubber. Moreover, an elastomeric material may be electrically insulating or semiconductive. For example, the body 214 may include a semiconductive rubber elastomeric material for shielding purposes and/or an insulative rubber elastomeric material.

The mechanical interface 226 is attachable to and removable from the bushing 205. The body 214 and the mechanical interface 226 surround a conductor 222 that is electrically connected to a cable 213. The cable 213 extends from an end 217 of the body 214.

The bushing 205 is on the electrical device 209, which is separate and distinct from the electrical connector 210. For example, device 209 may be a transformer, a sectionalizing cabinet, or a junction. The bushing 205 surrounds an electrical conductor 206 that is part of a distribution path 204. The mechanical interface 226 is configured such that, when the mechanical interface 226 is mounted to the bushing 205, the electrical connector 210 is held to the bushing 205 and the electrical conductor 222 is electrically connected to the conductor 206 and the distribution path 204. For example, the mechanical interface 226 may be held to the bushing 205 with an interference fit. In some implementations, the electrical connector 210 is configured to dead-break applications. In these implementations, the mechanical interface 266 is secured to the bushing 205 with a bolt connection.

FIG. 2B is a block diagram that shows additional details of the electrical connector 210.

The body 214 of the electrical connector 210 may be an electrically insulating material, such as, for example, hardened rubber, a polymer material, or an elastomeric material. The body 214 is a three-dimensional body. An exterior 211 of the body 214 may be completely or substantially covered with and/or made of a semiconductive or electrically conductive material. For example, the exterior 211 of the body 214 may be a semi-conductive or an electrically conductive shield or coating. The shield or coating may made of, for example, a molded peroxide-cured ethylene propylene diene monomer (EPDM). In some implementations, the electrical connector 210 includes a shell and insert that are separately molded from semiconductive rubber. These shell and insert are then placed in a tool and the space between the shell and the insert is filled with insulative rubber. The pieces are bonded together, creating one continuous piece with the shell being all or part of the exterior 211.

Referring also to FIG. 2C, the mechanical interface 226 is at the end 216 of the body 214 and surrounds the conductor 222. The mechanical interface 226 may be part of the body 214. The mechanical interface 226 has a shape in the X-Y plane that corresponds to the shape of the bushing 205 such that the mechanical interface 226 is mechanically mountable to the bushing 205. In the example of FIGS. 2B and 2C, the mechanical interface 226 has a circular cross-section in the X-Y plane.

Other implementations of the electrical connector 210 are possible. For example, the body 214 may have a shape other than shown in FIGS. 2A and 2B. In some implementations, the electrical connector 210 is an elbow-shaped or L-shaped connector, a U-shaped connector, a C-shaped connector, or a T-shaped connector. Moreover, the electrical connector 210 may include additional components that are not shown in FIGS. 2A-2C. For example, the electrical connector 210 may include an energy-harvesting apparatus and/or a current exchange. In another example, the electrical connector 210 may include a resettable current interrupting apparatus, such as a vacuum interrupter, in the body 214 and electrically connected to the current path 212. Moreover, in some implementations, the electrical connector 210 includes measurement sensors, such as, for example, current and/or voltage sensors. The electrical connector 210 also may include an electronic control and a communications interface that sends and receives information from an electronic device separate from the electrical connector 210.

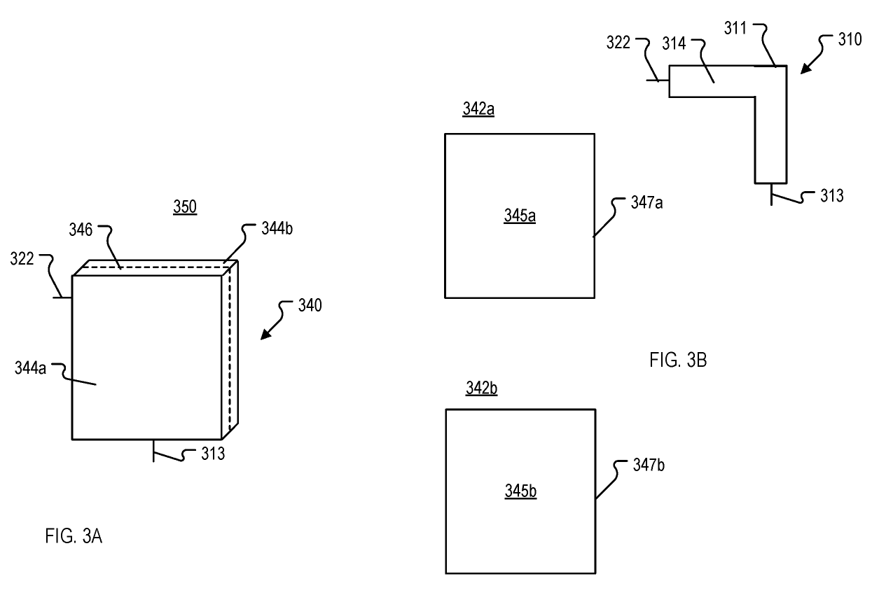

FIG. 3A is an exterior perspective view of an assembled system 350. FIG. 3B shows the system 350 in a disassembled state. The assembled system 350 includes an exoskeleton 340 that encompasses a body 314 of a separable electrical connector 310. The body 314 is an electrically insulating body and is made of an electrically insulating material. For example, the body 314 may be an elastomeric body. The exoskeleton 340 includes pieces 342a and 342b that are made of a rigid or semi-rigid material. For example, the pieces 342a and 342b may be made of a thermosetting material, a metal material, a metal alloy, or a composite material that includes more than one material. Moreover, the pieces 342a and 342b may be made of non-rigid materials that are strapped together or otherwise attached into a rigid structure. For example, the pieces 342a and 342b may be made of a flexible plastic material is encased in a solid encapsulant to provide rigidity. Each piece 342a, 342b includes a respective exterior surface 344a, 344b and a respective interior side 345a, 345b. In the example shown, the piece 342a, 342b are the same size and shape.

The electrical connector 310 includes the body 314, which has an exterior surface 311, and an electrical conductor 322 that passes through the body 314 to a cable 313. The body 314 is pre-formed and pre-molded component. The electrical connector 310 is shown as an elbow-shaped or L-shaped connector, but may have another shape.

To assemble the system 350, the electrical connector 310 is placed on the interior side 345b (or 345a) and the piece 342a is aligned with the piece 342b with the interior sides 345a, 345b facing each other and the electrical connector 310 captured in an interior region bounded by the interior sides 345a, 345b. The pieces 342a and 342b are attached to each other and secured to form the exoskeleton 340. Respective edges 347a and 347b of the pieces 342a and 342b are attached to each other at a seam 346 with, for example, an adhesive or by a process (for example, welding) that melts the edges of the pieces 342a and 342b together. In some implementations, the pieces 342a, 342b are held together by an interference fit, fasteners, or a snap fit generated by an interaction between the edges 347a and the edges 347b. The body 314 is inside the exoskeleton 340 and the cable 313 and the electrical conductor 322 extend outward from the exoskeleton 340.

Other implementations are possible. For example, the pieces 342a, 342b may be a pre-formed kit or assembly in which the pieces 342a, 342b are separate and distinct pieces that are coupled at a connection point such as, for example, a hinge. In these implementations, although the pieces 342a, 342b are technically connected prior to assembly of the exoskeleton 340, the pieces 342a, 342b are distinct pieces. Moreover, the system 350 may include more than the two pieces 342a, 342b. For example, the system 350 may include three, four, five, or more pieces that join together to form an exoskeleton.

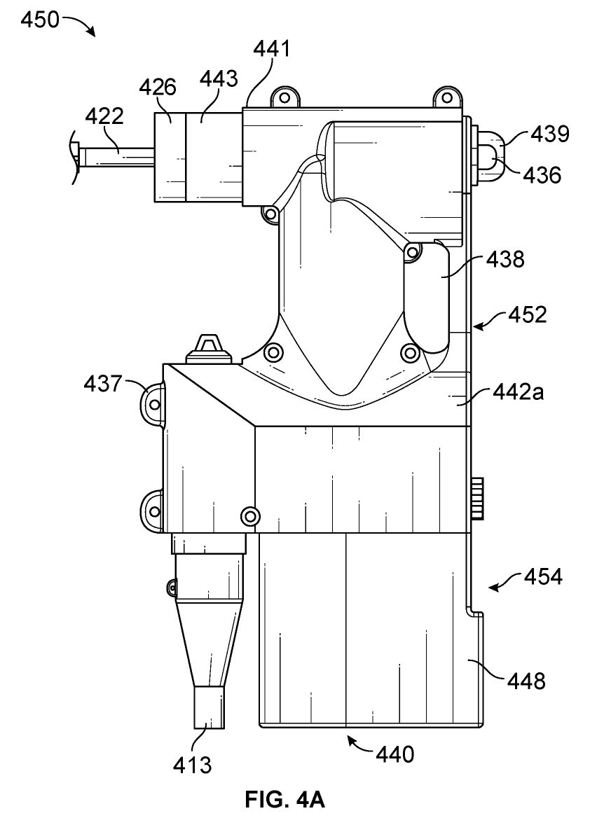

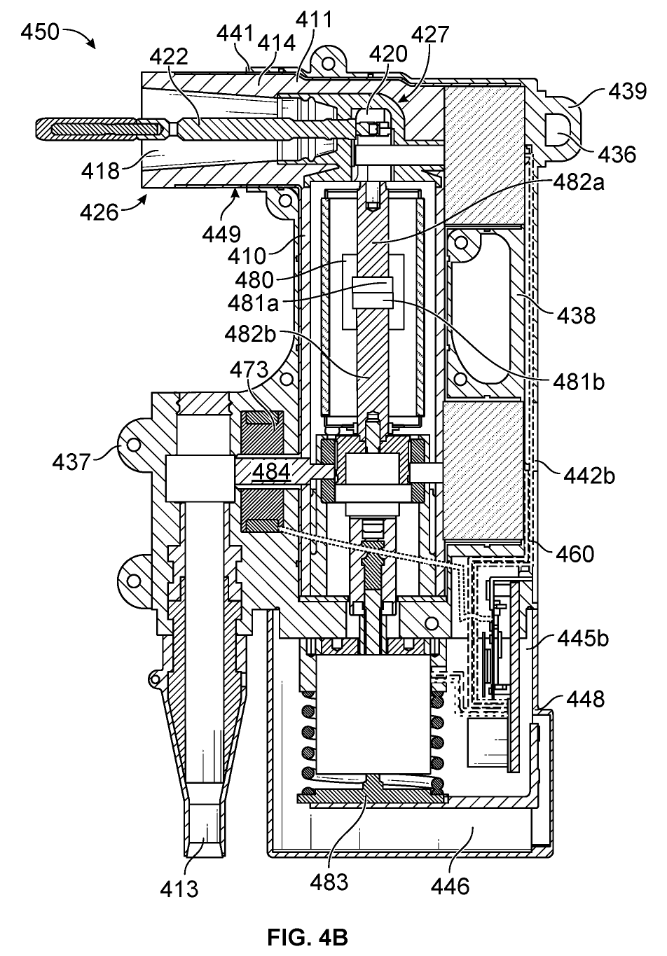

FIG. 4A is an exterior side view of another assembled system 450. FIG. 4B is a cross-sectional side view of the assembled system 450. The assembled system 450 includes an exoskeleton 440 and an electrical connector 410. Referring to FIG. 4A, the exoskeleton 440 includes an upper clamshell portion 452 and a lower portion 454. Each of the portions 452 and 454 includes two pieces that are mirror images of each other. The upper portion 452 includes pieces 442a and 442b (FIG. 4B). The lower portion 454 is a single piece 448. The single piece 448 has an open interior region. The pieces 442a, 442b, 448 are made of a rigid or semi-rigid material. For example, each piece 442a, 442b, 448 may be made of metal or a polymer.

Referring to FIG. 4B, which is a side cross-sectional view of the assembled system 450. The electrical connector 410 is set into an inner side 445b of the piece 442b. The electrical connector 410 may be set into the inner side 445b with an interference fit. For example, the inner side 445b of the piece 442b and an inner side of the piece 442a compress the electrical connector 410 in several locations to offer additional rigidity. The electrical connector 410 includes a body 414 and a connection interface 426 that extends from an open end region 418 of the body 414. The body 414 is an electrically insulating body, such as, for example, an elastomeric body. The body 414 has an exterior surface 411. The electrical connector 410 includes an electrical conductor 422 that extends into the open end region 418 from a fitting 420. The fitting 420 also holds a fixed conductor 482a of a vacuum interrupter 480. The electrical connector 410 is an elbow connector or an L-shaped connector, and the conductor 422 and the conductor 421 are perpendicular to each other. The fitting 420 electrically connects the conductor 422 and the fixed conductor 482a. The fitting 420 is surrounded by a semiconductive elastomeric insert 427 that is between the fitting 420 and an inner side of the body 414. The insert 427 creates a smooth surface around the fitting 420 to distribute electrical stress within the body 414.

The vacuum interrupter 480 includes a fixed electrical contact 481a, which is electrically connected to the fixed conductor 482a, and a moevable electrical contact 481b, which is electrically connected to a moveable conductor 482b. The moveable conductor 482b is coupled to an actuator 483, which is controllable to move the moveable conductor 482b and the moveable electrical contact 481b relative to the stationary electrical contact 481a. The moveable conductor 482b is also electrically connected to a current exchange 484. The current exchange 484 is an electrically conductive element that includes a flexible aspect such that the moveable conductor 482b can move while also maintaining an electrical connection with the current exchange 484. For example, the current exchange 484 may include a flexible wire, a flexible cable, a flexible conductive strip, or flexible braided wires that electrically connect the moveable conductor 482b to a cable 413. The current that flows in the current exchange 484 is measured and/or harvested by a current transformer 473. The current transformer 473 may be, for example, a Rogowski coil.

The electrical connector 410 (including the vacuum interrupter 480 and the current exchange 484) are positioned on the inner side 445b of the piece 442b. A semiconductive elastomeric shell 449 is between the exterior surface 411 of the body 414 and the inner side 445b. A portion 443 of the shell 449 extends toward the mechanical interface 426 beyond an end 441 of the pieces 442a and 442b. The shell 449 provides a protective deadfront shield. The shell 449 may, for example, be a peroxide-cured EPDM rubber. The actuator 483 is positioned within an interior 446 of the piece 448. The inner side 445b and the interior 446 also include channels 460 that accommodate low voltage wires.

Referring also to FIG. 4A, to assemble the system 450, the piece 442a is attached to the piece 442b to enclose the body 414 in an interior region defined by an inner side of the piece 442a and the inner side 445b of the piece 442b, and the actuator 483 is placed in the interior 446 of the piece 448.

The pieces 442a, 442b include sealing tabs 437 that are used to seal the pieces 442a, 442b together to form the sealed exoskeleton 440. The tabs 437 offer provision for fasteners to compress the seal between the pieces 442a and 442b. In some implementations, the body 414 also include small O-ring-like features that, when compressed by the inner side 445b and the inner side of the piece 442a to create a moisture barrier around the electrical connector 410. Additionally, the exoskeleton 440 includes a handle 438 and a pulling feature 439. The pulling feature 439 defines an opening 436 that is configured to receive a tool, such as, for example, a hook or an end of a hotstick.

Other implementations are possible. For example, the bottom portion 454 is a single piece in the example shown in FIGS. 4A and 4B. However, other implementations are possible. The bottom portion 454 may include two or more separate pieces that are connectable to form the bottom portion 454.

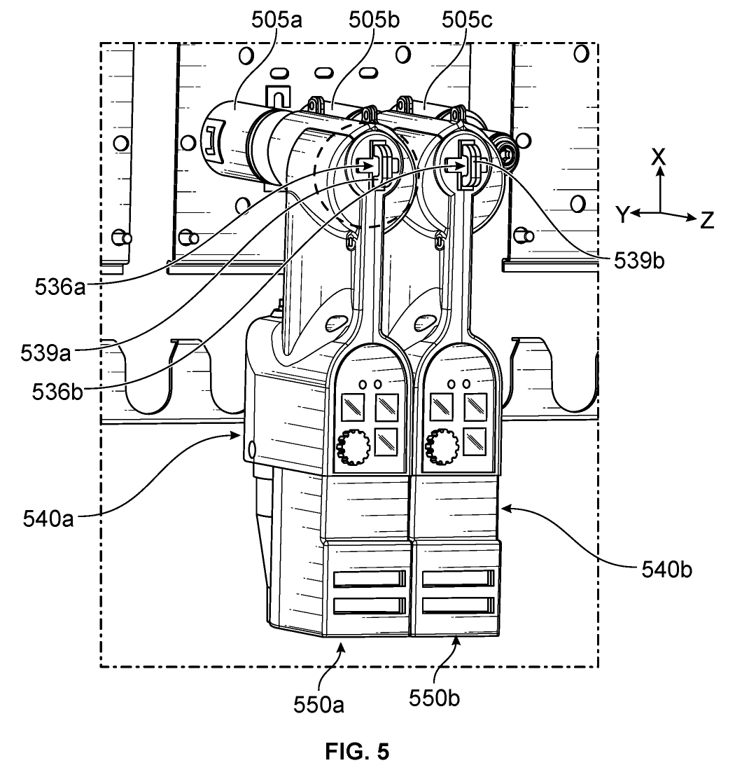

FIG. 5 is a rear-side exterior perspective view of assembled systems 550a, 550b mounted on respective bushings 505a, 505b. Each assembled system 550a, 550b includes a respective exoskeleton 540a, 540b. Each exoskeleton 540a, 540b includes a respective pulling feature 539a, 539b. The pulling feature 539a, 539b may be an integral part of the respective exoskeleton 540a, 540b. For example, the pulling features 539a, 539b may be molded into an exterior side of the respective exoskeleton 540a, 540b. In some implementations, the pulling features 539a, 539b are attached to an exterior of the respective exoskeleton 540a, 540b.

Regardless of its specific form, the pulling feature 539a defines an opening 536a that is accessible from an exterior of the exoskeleton 540. The opening 536a is configured to receive a tool such as, for example, a hook or an end of a hotstick. Similarly, the pulling feature 539b defines an opening 536b that is configured to receive a tool such as, for example, a hook or an end of a hotstick. With the tool in the opening 536a, a human operator can apply a force in the Z direction to the assembled system 550a to pull the assembled system 550a off the bushing 505a. Similarly, by placing the took in the opening 536b, a human operator can apply force in the Z direction to remove the assembled system 550b from the bushing 505b.

Other implementations are possible. For example, in some implementations, the human operator can grasp the pulling feature 539a and/or 539b without a tool to apply force in the Z direction and separate the assembled system 550a and/or 550b from the respective bushing 505a, 505b. Furthermore, in some implementations, the exoskeletons 540a and 540b are mechanically connected or coupled such that pulling the assembled system 550a off of the bushing 505a also causes the assembled system 550b to separate from the bushing 505b, and vice versa. Additionally, a third assembled system (not shown) that is identical to the assembled systems 550a and 550b may be attached to the bushing 505c.

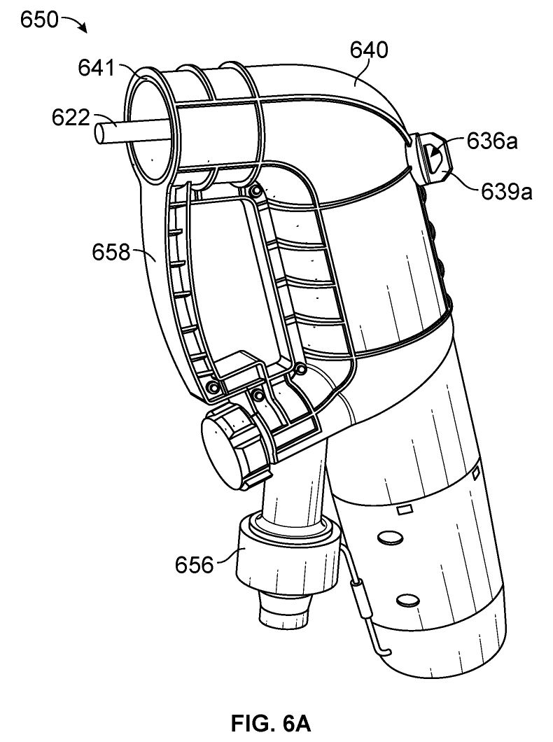

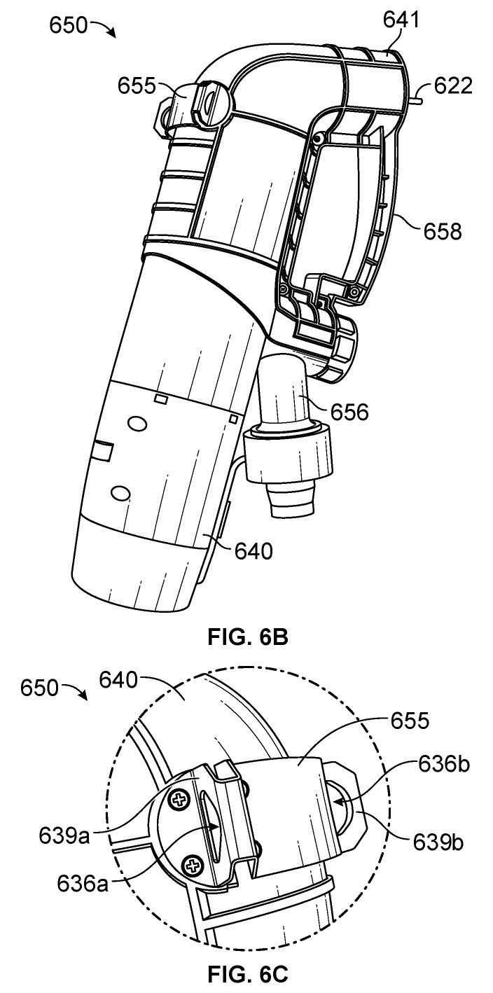

FIGS. 6A-6C relate to another assembled system 650. FIG. 6A is a front-side exterior perspective view of the assembled system 650 and FIG. 6B is a rear-side exterior view of the assembled system 650. The assembled system 650 includes an exoskeleton 640 that encloses an insulating body of a separable electrical connector (not shown). The electrical connector includes a conductor 622 that extends through an open end 641 of the exoskeleton 640. The open end 641 can be repeatedly mounted to and removed from a bushing such as the bushing 505a (FIG. 5). When the open end 441 is mounted to the bushing, the conductor 622 is electrically connected to a device associated with the bushing.

Referring also to FIG. 6C, which is a partial exterior view of the assembled system 650, the assembled system 650 includes a bracket 655 that is attached to an exterior of the exoskeleton 640 and an entrance point 656 for a cable (such as the cable 113). The bracket 655 has a pulling feature 639a, which defines an opening 636a, and a pulling feature 639b, which defines an opening 636b. Each opening 636a, 636b is configured to receive a tool that aids removing the assembled system 650 from a bushing. Examples of such a tool include, for example, a hook or a hotstick. The bracket 655 includes the two openings 636a, 636b. The two-opening configuration shown in FIGS. 6A-6C may be helpful for situations in which a two-person installation or two-person removal. Other implementations are possible. For example, the bracket 655 may include just one opening instead of the openings 636a, 636b.

The exoskeleton 640 includes a handle 658. The handle 658 is graspable by a human user and provides an ergonomic aid for carrying the assembled system 650. The handle 658 allows the human user to easily carry the assembled system 650 to and/or from, for example, a cabinet, installation site, or a transport mechanism (such as a truck). Additionally, the handle 658 can provide cantilever support while the assembled system 650 is mounted to a bushing. In some implementations, the interior of the handle 658 is used to route low-voltage wires.

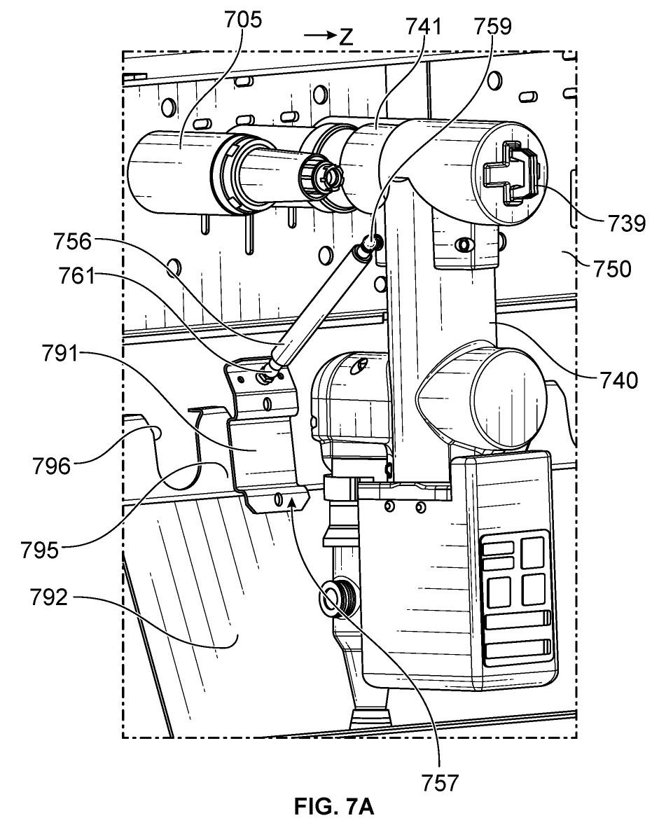

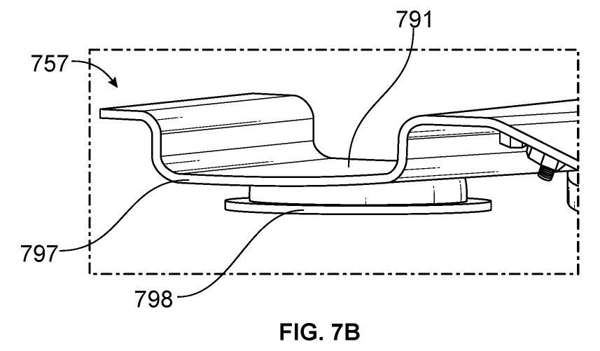

FIG. 7A is a side-rear view of another assembled system 750. The assembled system 750 is shown in a cabinet that has a wall 792 and a support rail 795 mounted on the wall 792. The assembled system 750 includes an exoskeleton 740 and a pulling feature 739. A support stand 756 is attached to and extends from the exterior of the exoskeleton 740. One end of the support stand 756 is attached to the exoskeleton 740 at a connection point 759. The other end of the support stand 756 is attached to a connection point 761 on a bracing element 757 that is mounted to the support rail 795.

The connection points 759 and 761 may be joints that allow the support stand 756 to move relative to bracing element 757 and the assembled system 750. In these implementations, the connection points 759 and 761 may be, for example, a ball and socket joint or a pivot point. Other implementations are possible. For example, the connection points 759 and 761 may be rigid connections that do not allow movement. In these implementations, the support stand 756 is installed after the assembled system 750 is mounted to a bushing 705.

The support stand 756 may be a rod. In some implementations, the support stand 756 is a spring-loaded cylinder or rod. Using a spring-loaded cylinder or rod as the support stand 756 allows the support stand 756 to have an adjustable length and to connect to mounting points in different locations. The spring also allows the support stand 756 to fill the desired distance while also pushing against the connector to provide support.

The bracing element 757 is mounted to the support rail 795. Referring also to FIG. 7B, which is a side perspective view of the bracing element 757, the bracing element 757 includes a bracket with a first side 791 and a second side 797. The second side 797 is opposite the first side 797, and a disk-like element 798 extends from the second side 797. The bracing element 757 is attached to the rail 795 by sliding the disk-like element 798 into a U-shaped parking feature 796 in the rail 795. The bracing element 757 may be complimented by a locking mechanism to prevent the assembled system 750 from being unintentionally removed from the bushing 705. For example, a bail hook or bail assembly may be inserted into the holes in the bushing 705 with an eyebolt pressing against the pulling feature 739.

To attach the assembled system 750 to a bushing 705, an open end 741 of the assembled system 750 is moved in the -Z direction, toward the bushing 705 and pressed onto the bushing 705 to secure the assembled system 750 to the bushing 705.

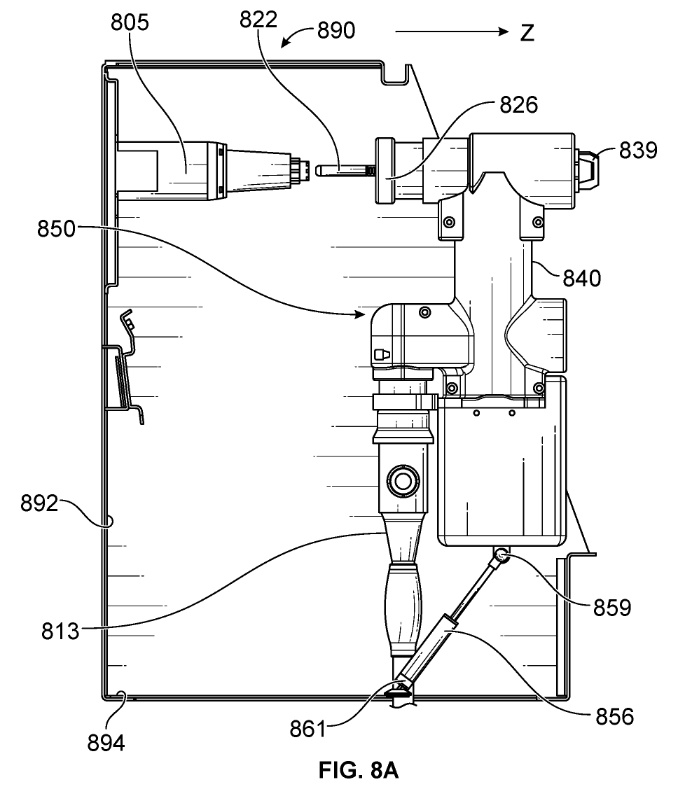

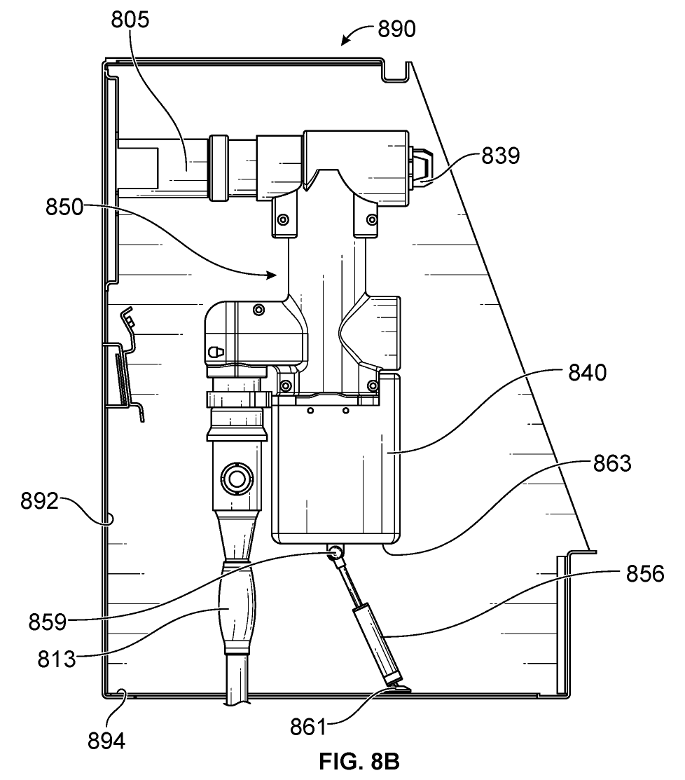

FIGS. 8A and 8B show an interior of a cabinet 890. The cabinet 890 includes a wall 892 and a bushing 805 that extends from the wall 892. FIG. 8A shows an assembled system 850 prior to being mounted to the bushing 805, and FIG. 8B shows the assembled system 850 mounted to the bushing 805. The assembled system 850 includes an exoskeleton 840 that encloses an insulated body of a separable electrical connector (not shown). The electrical connector includes a conductor 822 that extends through a connection interface 826. The conductor 822 is electrically connected to a cable 813 that extends through a bottom or cabinet pad 894 of the cabinet 890. The exoskeleton 840 also includes a pulling feature 839 and a support stand 856. The support stand 856 is attached to a connection point 859 on a bottom side 863 of the exoskeleton 840 and to a connection point 861 on the bottom or cabinet pad 894 of the cabinet. The connection points 859 and 861 are any type of connection point that allow the support stand 856 to move in the plane of the page. For example, the connection points 859 and 861 may be pivot points or ball and socket joints.

Referring to FIG. 8A, to attach the assembled system 850 to the bushing 805, the assembled system 850 is pushed in the -Z direction until the connection interface 826 is secured to an exterior of the bushing 805, as shown in FIG. 8B. While the assembled system 850 moves in the -Z direction, the stand 856 rotates about the connection points 859 and 861 such that the stand 856 remains connected to the bottom or cabinet pad 894 of the cabinet 890 while the assembled system 850 moves and while the assembled system 850 is mounted to the bushing 805.

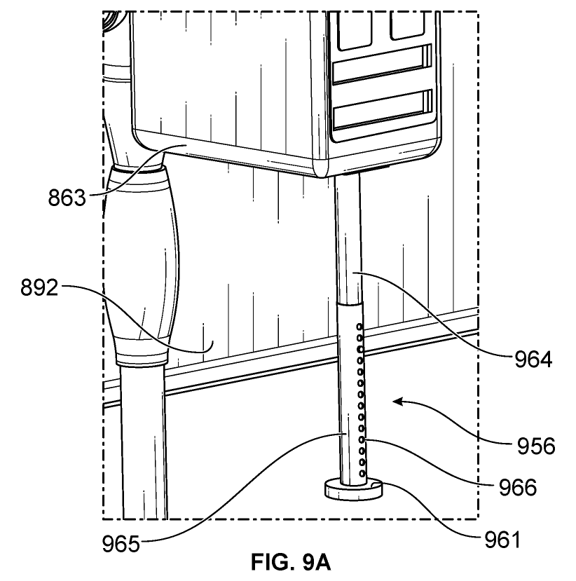

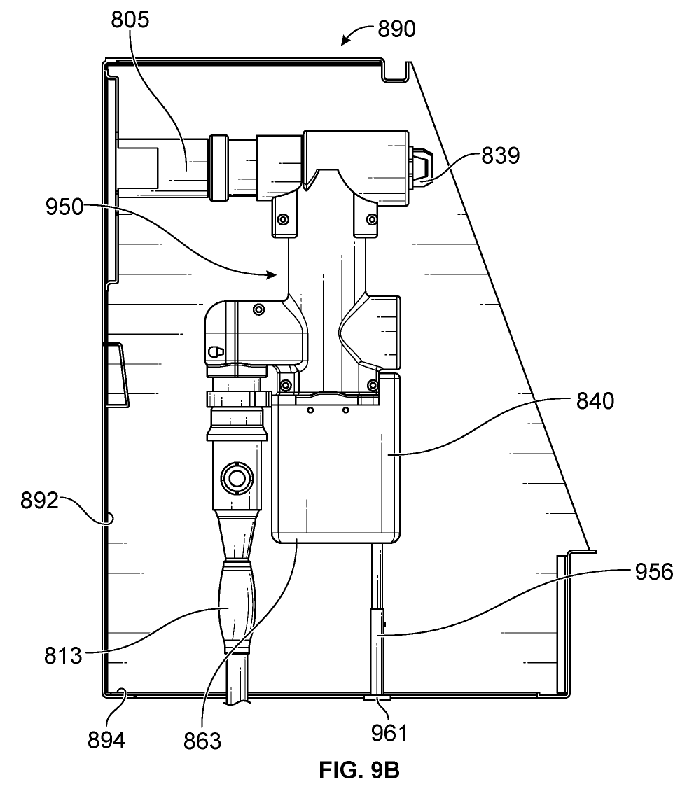

FIGS. 9A and 9B show another assembled system 950. The assembled system 950 is the same as the assembled system 850 (FIGS. 8A and 8B) except the assembled system 950 includes a support stand 956 instead of the support stand 856. The support stand 956 extends from the bottom 863 of the exoskeleton 840 and ends at a foot 961. FIG. 9B shows the assembled system 950 in the cabinet 890 and mounted to the bushing 805. The support stand 956 is a drop-down leg that extends from the bottom 863 to the bottom or cabinet pad 894 of the cabinet 890. The support stand 956 includes an inner portion 964 and an outer portion 965 that slide relative to each other such that the length of the support stand 956 is adjustable. The support stand 956 also includes a locking mechanism 966 to lock the support stand 956 at a particular length. In the example of FIGS. 9A and 9B, the locking mechanism 966 includes openings that pass through the outer portion 965 and a peg that extends radially outward from the inner portion 964. By positioning the peg in a particular one of the openings, the support stand 956 is set to one of a plurality of possible lengths.

Other implementations of the support stand 956 are possible. For example, in some implementations, the support stand 956 attaches to the side of the exoskeleton 840 with features that allow the appropriate height to be chosen.

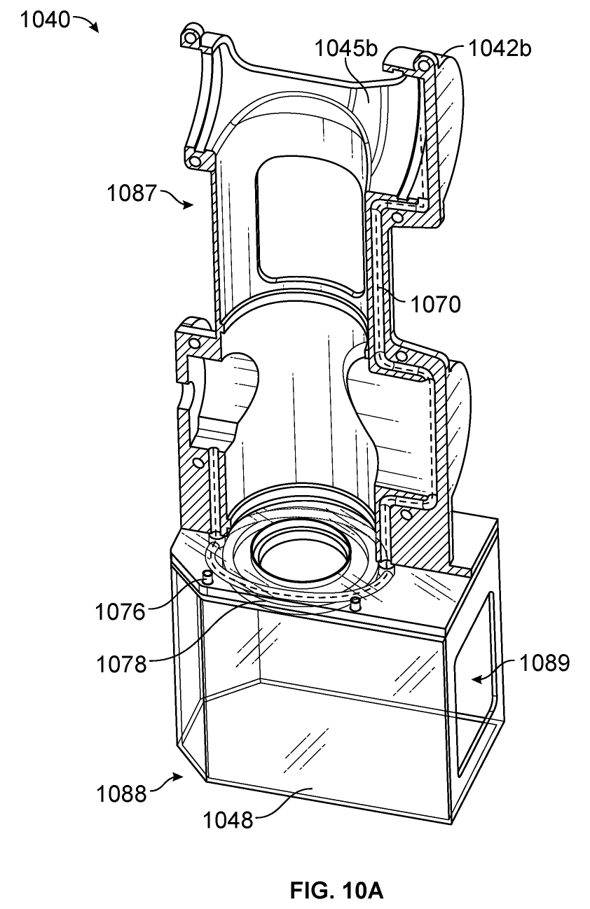

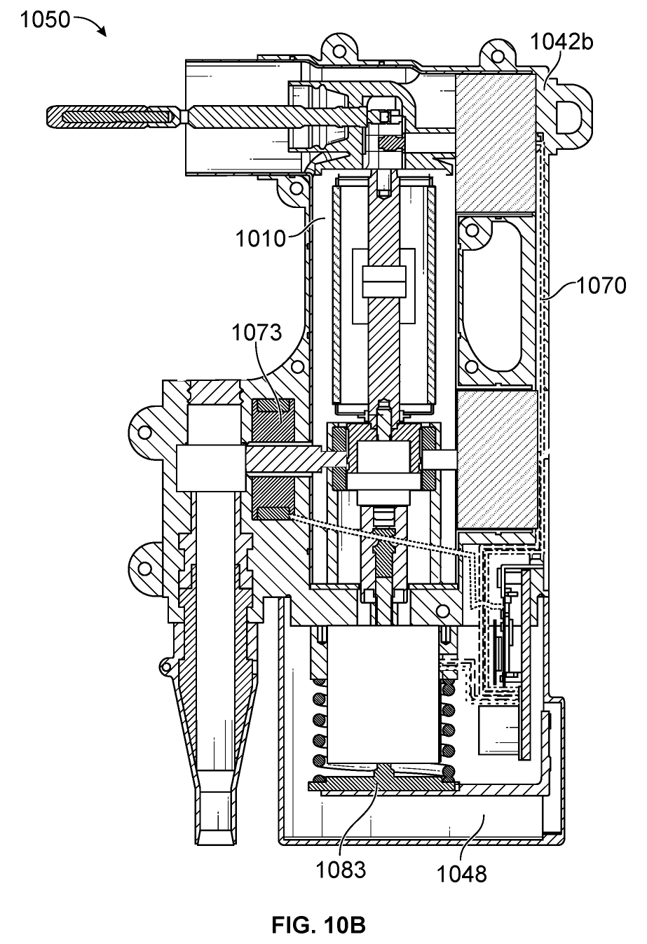

FIG. 10A is a perspective partial view of an exoskeleton 1040. FIG. 10B is a cross-sectional view of an assembled system 1050 that includes the exoskeleton 1040 and an electrical connector 1010. The electrical connector 1010 is similar to the electrical connector 410 (FIG. 4B).

Referring to FIG. 10A, the exoskeleton 1040 includes a lower portion 1088 and an upper portion 1087. The lower portion 1088 is a single piece 1048 that defines an interior 1089. Although the lower portion 1088 is shown as a single piece in the example of FIGS. 10A and 10B, the lower portion 1088 may include one or more pieces. The upper portion 1087 includes a piece 1042b that is mounted to a partition plate 1078, which is sealed with gaskets 1076 to the lower portion 1088. The upper portion 1087 also includes a second piece (not shown) that is the mirror image of the piece 1042b and is also mounted to the partition plate 1078. The partition plate 1078 separates an interior of the upper portion 1087 from an interior 1089 of the lower portion 1088.

Referring also to FIG. 10B, in the assembled system 1050, an actuator 1083 and associated control elements are in the interior 1089 of the lower portion 1088 and the electrical connector 1010 is in the interior of the upper portion 1087 of the exoskeleton 1040. Low-voltage wiring 1070 is routed in the interior of the exoskeleton 1040. The low-voltage wiring 1070 may be electrical wires that are separate from the exoskeleton 1040 and/or conductive traces that are printed directly onto an interior surface of the exoskeleton 1040 (for example, on an interior surface of the piece 1045b and/or the piece 1042b). The low-voltage wiring 1070 may be used to carry electrical current for energy harvesting and/or sensing. For example, in the implementation shown in FIG. 10B, the low-voltage wiring 1070 includes electrical connections to a current transformer 1073. The current transformer 1073 may be, for example, a Rogowski coil. Furthermore, the low-voltage wiring 1070 may carry electrical current harvested with the current transformer 1073 into the lower portion 1088 to to drive the actuator 1083 and/or to power a control module.

Other implementations are possible, and low-voltage wires may be routed in other ways. For example, low-voltage wires may be routed on the partition plate 1078. Moreover, the exoskeleton 1040 may be implemented without the partition plate 1078.

These and other implementations are within the scope of the claims.

What is claimed is:

1. A system comprising:
a separable electrical connector comprising:
an elastomeric body; and
an electrical conductor, wherein at least part of the electrical conductor is surrounded by the elastomeric body; and
an exoskeleton configured to provide mechanical support to the separable electrical connector, the exoskeleton comprising: two or more attached pieces of material that define an exterior surface and an interior region, and wherein the elastomeric body is in the interior region.

2. The system of claim 1, wherein the exoskeleton further comprises a pulling feature that extends from the exterior surface.

3. The system of claim 1, further comprising a support leg configured to be extended between the exterior surface and an external object.

4. The system of claim 1, wherein the exoskeleton further comprises a handle that extends from the exterior surface.

5. The system of claim 4, wherein the handle is configured to be grasped by a human operator.

6. The system of claim 1, wherein each of the two or more attached pieces comprises an inner side that faces the interior region, and further comprising one or more wire routing features on the inner side of at least one of the two or more attached pieces.

7. The system of claim 6, wherein at least one of the one or more wire routing features comprises an electrically conductive trace on the inner side of at least one of the attached pieces.

8. The system of claim 1, wherein each of the two or more attached pieces is a piece of rigid material.

9. The system of claim 1, wherein each of the two or more attached pieces is a piece of semi-rigid material.

10. The system of claim 1, wherein each of the two or more attached pieces is formed as an individual piece of material prior to being attached.

11. The system of claim 1, wherein the exterior surface is electrically conductive.

12. The system of claim 1, further comprising a semiconductive elastomeric shell on at least part of the exterior surface.

13. The system of claim 1, wherein the elastomeric body extends in at least two directions.

14. An exoskeleton for a separable electrical connector, the exoskeleton comprising:
a plurality of individual solid pieces configured to be attached to each other as a single-piece structure, the single-piece structure comprising an interior region and an exterior surface, wherein the interior region is configured to enclose at least part of an insulating body of the separable electrical connector, each of the individual solid pieces is pre-formed as a piece of material prior to being attached to one or more of other of the individual solid pieces, and each of the individual solid pieces comprises an inner side that faces the interior region;
a pulling feature that extends from the exterior surface;
a handle that extends from the exterior surface and is configured to be grasped by a human operator; and
a support leg that extends from the exterior surface and is configured to support the exoskeleton relative to an external object.

15. The exoskeleton of claim 14, wherein at least one inner side comprises a channel configured to route an electrical wire.

16. The exoskeleton of claim 14, wherein each individual solid piece is a piece of rigid material.

17. The exoskeleton of claim 14, wherein, when the individual solid pieces are attached to each other as the single-piece structure, the single-piece structure is fluidly sealed.

18. The exoskeleton of claim 14, wherein, when the individual solid pieces are attached to each other as the single-piece structure, the single-piece structure provides mechanical support to the elastomeric electrical connector and counteracts a cantilever force experienced by the elastomeric electrical connector.

19. The exoskeleton of claim 14, wherein the pulling feature is configured for interaction with a hotstick.
